(19) United States
(12) Patent Application Publication
(10) Pub. No.: US 2017/0071395 A1
(43) Pub. Date: Mar. 16, 2017

(54) CAPSULE AND METHOD FOR PRODUCING A BEVERAGE

(71) Applicant: K-FEE SYSTEM GMBH, Bergisch-Gladbach (DE)

(72) Inventors: Marc Krüger, Bergisch-Gladbach (DE); Günter Empl, Bergisch-Gladbach (DE)

(73) Assignee: K-Fee System GmbH, Bergisch Gladbach (DE)

(21) Appl. No.: 15/123,335

(22) PCT Filed: Mar. 24, 2015
(86) PCT No.: PCT/EP2015/056306

§ 371 Date: Sep. 2, 2016

(30) Foreign Application Priority Data
Mar. 24, 2014 (DE) 102014103983.1

(51) Int. Cl. A47J 31/36; B65D 21/08; B65D 85/804

(52) U.S. Cl. CPC A47J 31/369; B65D 85/8043; B65D 21/086

(57) ABSTRACT

The invention relates to a method for producing a drink or food item, in which a liquid flows through a capsule and a drink/food item substance is dissolved and/or extracted. The invention also relates to a capsule comprising a capsule body, the outer body and base thereof defining an inner chamber in which a beverage/food item substance is provided. Said beverage/food item substance is dissolved and/or extracted by a liquid which is guided through the capsule.

The present invention relates to a method for producing a beverage or foodstuff where a liquid flows through a capsule and in so doing dissolves and/or extracts a beverage substance/foodstuff substance. In addition, the present invention relates to a capsule having a capsule body, the wall and bottom of which delimit an interior in which is provided a beverage substance/foodstuff substance which is dissolved and/or extracted by means of a liquid which is introduced into the capsule.

Capsules are used increasingly nowadays for the purpose of preparing beverages or foodstuffs. To this end, the capsule is traversed by a liquid, in particular hot water, and at the same time a beverage substance/foodstuff substance which is present in the capsule is extracted and/or dissolved. The resultant beverage, however, often does not have enough flavor.

It has consequently been the object of the present invention to provide a capsule which does not comprise the disadvantages of the prior art.

The object is achieved with a method for producing a beverage or foodstuff where a liquid flows through a capsule and in so doing dissolves and/or extracts a beverage substance/foodstuff substance, wherein the capsule is distorted prior to and/or during production of the beverage and at the same time the beverage substance/foodstuff substance is compressed.

The statements made with regard to said object of the present invention are equally applicable to the other objects of the present invention and vice versa. Features of said object of the present invention can be combined with features of other objects of the present invention.

The present invention relates to a method for producing a beverage or foodstuff, where a liquid flows through a capsule and in so doing dissolves and/or extracts a beverage substance/foodstuff substance. The capsule is provided with a capsule body which comprises a wall, for example a cylindrical or conical wall, and a bottom, which together delimit an interior, in said interior is provided a beverage substance/foodstuff substance, with which, for example, tea, coffee, expresso but also a foodstuff, such as, for example, soup, is able to be produced, by a liquid, in particular hot water, which dissolves and/or extracts the beverage substance/foodstuff substance, being directed through the capsule. The beverage substance/foodstuff substance is, for example, coffee powder or tea leaves, but also dried milk or chocolate powder.

According to the invention, the capsule is distorted prior to and/or during production of the beverage and at the same time the beverage substance/foodstuff substance is compressed. As a result, the substance is traversed in a more uniform manner. As an alternative to this or in addition to it, the flow resistance of the substance bulk is increased, as a result of which the quality of the resulting beverage or foodstuff is enhanced.

A liquid distributor, which distributes the liquid supply, which is introduced into the capsule, as a rule, as a water jet, at least in part over the cross section of the capsule, is preferably provided in the interior, in particular downstream of the liquid supply and upstream of the beverage substance/foodstuff substance. As an alternative to this, the liquid is supplied into the brewing chamber upstream of the cover and is introduced in a pre-distributed manner into the capsule interior through preferably several openings, in particular pierced openings, which are made in the cover, in particular the cover foil, preferably by a piercing member, and is then distributed additionally, where applicable, in a second stage by the liquid distributor at least in part over the cross section of the capsule. The liquid distributor reduces the speed at which the liquid contacts the beverage substance/foodstuff substance.

According to a preferred embodiment, the liquid distributor is a plastics material component which is able to be, for example, injected and/or deep-drawn.

The axial extension of the capsule is preferably reduced. In particular, when the two halves of the brewing chamber are joined together in their longitudinal extension, i.e. parallel to the axis of rotational symmetry or parallel to the direction of flow of the liquid which flows through the capsule, the capsule is pressed together, as a result of which the volume of the capsule is reduced and at the same time the beverage substance/foodstuff substance is compressed. In this case, the density of the filling material of the beverage substance/foodstuff substance is changed and/or the beverage substance/foodstuff substance is redistributed in the capsule. The compression can be effected by means of a plastic and/or elastic deformation of the capsule wall. For example, the wall of the capsule can comprise predetermined folding points which preferably extend along the entire periphery of the wall of the capsule, but in a particularly preferred manner only extend in a past region of the axial extension thereof, and which promote the deformation thereof.

As an alternative, to this or in addition to it, the radial extension of the capsule is reduced at least in portions, i.e. is pressed together transversely with respect to the axis of rotational symmetry or perpendicular to the direction of flow of the liquid which flows through the capsule, as a result of which the volume of the capsule is reduced and at the same time the beverage substance/foodstuff substance is compressed. In this case, the density of the filling material of the beverage substance/foodstuff substance is changed and/or the beverage substance/foodstuff substance is redistributed in the capsule. The compression process can be effected by means of a plastic and/or elastic deformation of the capsule wall. For example, the wall of the capsule can comprise predetermined folding points which promote the deformation thereof. The pressing together can be effected in a certain region of the wall of the capsule or over the entire periphery thereof and/or over the entire height of the wall of the capsule. For example, the wall of the capsule can comprise predetermined folding points which preferably extend along the axial extension of the wall of the capsule, but in a particularly preferred manner only extend in a part region of the periphery thereof, and which promote the deformation thereof.

A further object of the present invention is a capsule having a capsule body, the wall and bottom of which delimit an interior in which is provided a beverage substance/foodstuff substance which is dissolved and/or extracted by means of a liquid which is introduced into the capsule, characterized in that the wall and/or the bottom are provided so as to be compressible.

The statements made with regard to said object of the present invention are equally applicable to the other objects of the present invention and vice versa. The features of the individual objects of the present invention can be combined together.

A further object of the present invention is a system consisting of a brewing chamber, into which a capsule according to the invention is inserted, and of a brewing piston which closes the brewing chamber and on which a piercing member, by way of which the capsule is opened, is provided, wherein a means, by way of which the volume of the capsule is reducible during or prior to the production of the beverage or the foodstuff, is provided on the brewing chamber and/or the brewing piston.

The statements made with regard to said object of the present invention are equally applicable to the other objects of the present invention and vice versa. The features of the individual objects of the present invention can be combined together.

The brewing chamber, in particular the part which receives the capsule body, is preferably provided in a segmented/divided manner, wherein the segments are movable, relative to one another such that they press the capsule body together in a radial and/or axial manner. Once the capsules have been inserted into the brewing chamber, the segments/parts are moved toward one another and, as a result, the radial extent of the capsules and/or the axial extension of the capsules is/are reduced. Once the brewing operation has been concluded, the segments/parts are able to be moved apart from one another again and the capsules can be ejected.

The inventions are explained below by way of the figures. Said explanations are simply as an example and do not restrict the general inventive concept.

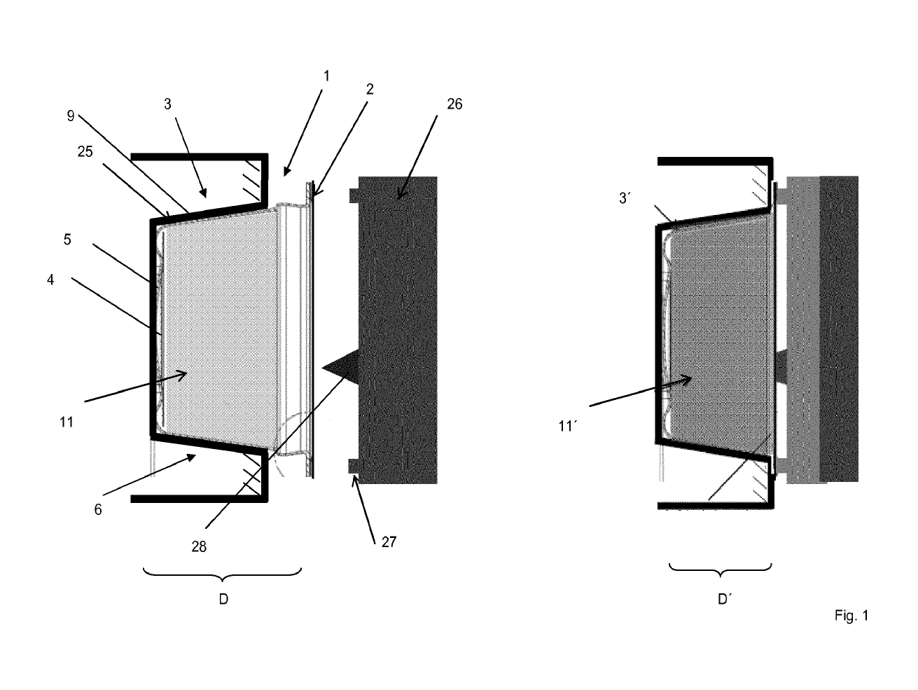

FIGS. 1-3 each show an embodiment of the method according to the invention, of the capsule according to the invention and of the system according to the invention.

FIG. 1 shows a first embodiment of the system according to the invention which comprises a capsule 1 which consists of a capsule body, for example a capsule body that has been injected or deep-drawn from a plastics material, and a cover, in particular a cover foil, the cover foil preferably being provided, in particular sealed-on, on a flange of the capsule body. In the interior of the capsule, in particular in the capsule body, is situated the beverage substance/foodstuff substance which is traversed and at the same time extracted to produce a beverage or foodstuff. For the traversing, the cover foil is pierced, for example, by a piercing mandrel 28 and then a liquid, in particular hot water, is introduced into the capsule, as a result of which the beverage substance/foodstuff substance is extracted and/or dissolved. Once the beverage substance/foodstuff substance has been traversed by the liquid, the beverage or foodstuff produced In this manner leaves the capsule, for example through the bottom of the capsule. A filter element 4, by way of which particles are prevented from being washed out of the capsule, can be provided in the interior of the capsule body. In addition, the system according to the invention comprises a brewing chamber 25 in which, in the present case, the capsule body is received at least in part. In addition, the system comprises a brewing piston 26 on which are provided here the piercing mandrel 28 and in the present case a sealing ring 27 and which is displaced in the direction of the brewing chamber 25, i.e. to the left here, for producing the beverage. In the right-hand part of FIG. 1, the system is shown in its closed state, in which the brewing piston 26 presses the flange of the capsule 1 against the brewing chamber 25, as a result of which the seals 27 seal the brewing piston against the capsule. At the same time, the piercing mandrel has pierced through the cover foil such that the liquid is able to flow into the capsule. As a comparison between the left-hand and the right-hand part of FIG. 1 shows, the capsule has been reduced from its original axial extension D to the axial extension D′ during the movement of the brewing piston. i.e. the wall of the capsule has been compressed in the axial direction parallel to the axis of the rotational symmetry of the capsule or parallel to the direction of flow of the liquid. At the same time, the beverage substance/foodstuff substance, which is situated in the capsule, was also compressed, as a result of which, on the one hand, the beverage substance/foodstuff substance can be redistributed inside the capsule and/or the density of the beverage substance/foodstuff substance is Increased by the cavities between the individual particles of the filling material being reduced. As a result, the flow resistance of the filling material of the beverage substance/foodstuff substance increases, which results, for example, in a better distribution of the liquid over the cross section of the capsule and, as a result, in a better extracting and/or dissolving performance of the beverage substance/foodstuff substance. The extraction of the beverage substance/foodstuff substance is improved by the high degree of flow resistance.

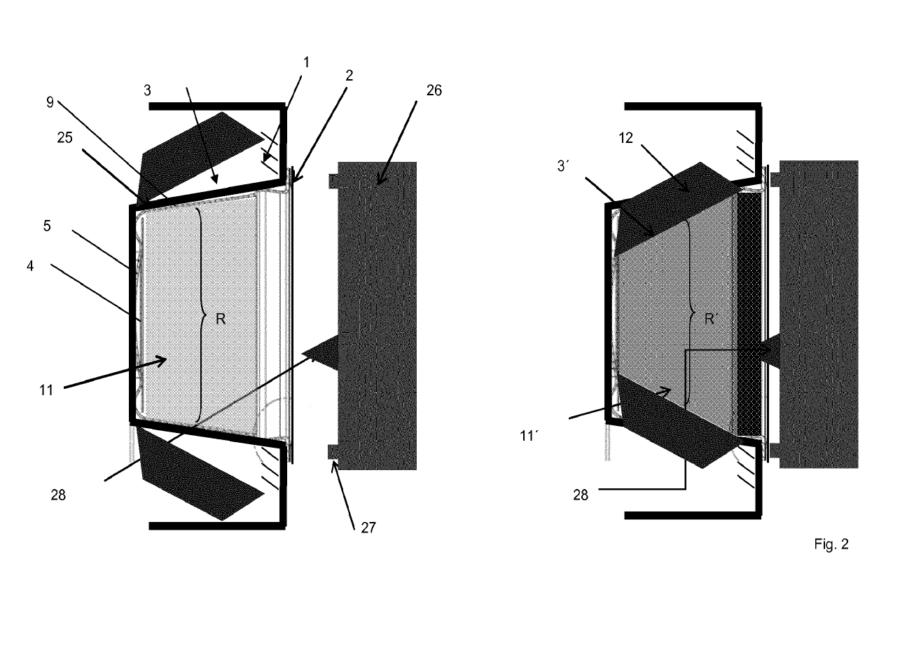

FIG. 2 shows a further embodiment of the present invention, it being possible to refer at least in part to the statements according to FIG. 1. In the present case, as an alternative to or in addition to compressing the capsule in an axial manner, it is able to be compressed in a radial manner such that the capsule body 3 is reduced from its original radius R (left-hand representation) to the radius R′ (right-hand representation). This Is effected in the present case by segmenting the brewing chamber, the parts of the brewing chamber which abut in particular against the radial extent of the capsule chamber between the bottom and the flange, being able to be moved toward or away from one another, as a result of which the capsule is pressed together and the beverage substance/foodstuff substance is compacted again. The movement can be a rotation or a linear movement or a combination of the two. The capsule is inserted Into the brewing chamber 25 in this case and the brewing piston is moved to abut against the cover of the capsule. The movable segments/parts are then moved toward one another until either a certain pressure is present and/or the volume has been reduced by a certain proportion. The beverage and/or foodstuff to be produced is then produced by a liquid, in particular hot water, flowing through the capsule. Once the production of the beverage and/or the foodstuff has been finished, the two parts are moved back again into their original position and the capsule can be ejected.

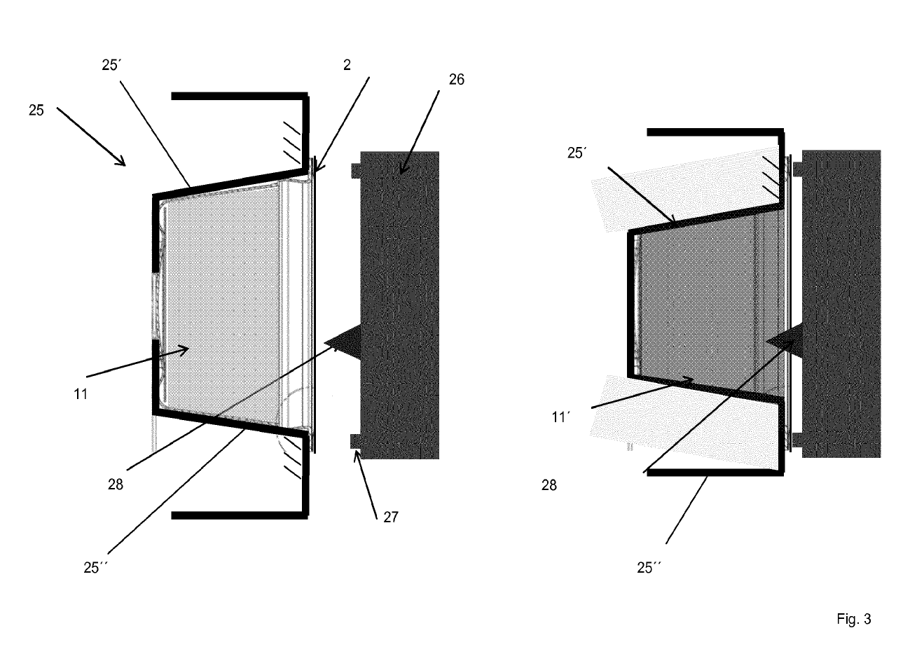

Yet another embodiment of the system according to the invention is shown in FIG. 3, it being possible essentially to refer to the statements according to FIG. 2. The brewing chamber 25 is also realized in two or multiple parts in the present case, the two parts 25′, 25″ being provided at a certain spacing with respect to one another, which can be seen in the left-hand representation in FIG. 3. As soon as the capsule has been inserted into the brewing chamber and in particular after the brewing piston has been moved in the direction of the brewing chamber 25 and abuts against the flange of the capsule, the two parts 25′, 25″ of the capsule are moved toward one another, in this case in a linear manner, as a result of which, once again, the volume of the capsule is reduced and consequently the density and/or the position of the beverage substance/foodstuff substance is changed.

### LIST OF REFERENCES

1 Capsule

2 Cover, cover foil

3 Capsule body

3′ Capsule body pressed together

4 Filter element

5 Capsule bottom

6 Crumple zone

9 Capsule wall

11 Beverage substance/foodstuff substance

11″ Compressed beverage substance/foodstuff substance

12 Movable segment, part means

25 Brewing chamber

25′ First part of the brewing chamber

25″ Second part of the brewing chamber

28 Brewing piston

27 Sealing ring on the brewing piston

28 Piercing mandrel

D Axial extension of the capsule

D′ Shortened axial extension of the capsule

R Radial extension of the capsule

R′ Reduced radial extension

1. A method for producing a beverage or foodstuff, the method comprising steps of:
flowing a liquid through a capsule that comprises a wall and a bottom so that coffee power or tea leaves is extracted,
wherein the wall of the capsule is distorted prior to and during production of the beverage and at the same time the coffee power or tea leaves compressed by a predetermined folding point in the wall being compressed.

2. The method of claim 1, wherein the method comprises a step of reducing an axial extension of the capsule.

3. The method of claim 1, wherein the method comprises a step of reducing a radial extension of the capsule at least in portions.

4. A capsule comprising:
a capsule body, the capsule body comprising:
a wall; and
a bottom
wherein the wall and the bottom delimit an interior of the capsule body in which coffee powder or tea leaves is provided,
wherein the coffee powder or tea leaves is by means of a liquid that is introduced into the capsule,
wherein the wall and/or the bottom are provided so as to be compressible, and
wherein predetermined folding points are provided in the wall.

5. (canceled)

6. (canceled)

7. (canceled)

8. (canceled)

9. (canceled)

10. The method of claim 1, wherein the predetermined folding points are provided in the wall adjacent a cover foil.

11. The method of claim 1, wherein the method includes a step of compressing the wall and/or the bottom with a brewing piston.

12. The method of claim 11, wherein the capsule includes a cover foil, and the method includes a step of piercing the cover foil with a piercing mandrel provided on the brewing piston.

13. The method of claim 1, wherein the method includes a step of compressing the wall and/or the bottom via moveable segments that are moved towards one another while the capsule located between the moveable segments.

14. The capsule of claim 4, wherein an axial extension of the capsule is reduced.

15. The capsule of claim 4, wherein at least in portions a radial extension of the capsule is reduced in a direction that is perpendicular to a direction that the liquid is introduced into the capsule.

16. The capsule of claim 4, wherein the wall and/or the bottom are provided so as to be compressible so that the coffee power or tea leaves is compressed and redistributed in the capsule.

17. The capsule of claim 4, wherein the predetermined folding points are provided in the wall adjacent a cover foil.

18. The capsule of claim 17, wherein the wall and/or the bottom is compressed via a brewing piston.

19. The capsule of claim 4, wherein the wall and/or the bottom is compressed via moveable segments that are moved towards one another.

20. The capsule of claim 4, wherein the capsule body comprises a filter element so that particles are prevented from being washed out of the capsule.
